(19) United States
(12) Patent Application Publication
(10) Pub. No.: US 2026/0359430 A1
(43) Pub. Date: Nov. 12, 2026

(54) SYSTEMS AND METHODS FOR AUTOMATING ANOMALY DETECTION

(71) Applicant: Fidelity Information Services, LLC, Jacksonville, FL (US)

(72) Inventor: Ranadhir GHOSH, St. Johns, FL (US)

(21) Appl. No.: 19/202,481

(22) Filed: May 8, 2025

(51) Int. Cl. G06F 21/55; H04L 9/40

(52) U.S. Cl. CPC G06F 21/554; H04L 63/1425

(57) ABSTRACT

Systems and methods are disclosed for automating anomaly detection. One method may include retrieving one or more data metrics from a data server, mapping, by a machine learning model, the one or more data metrics using one or more logic rules, determining, by the machine learning model, one or more patterns based on the mapping, determining, by the machine learning model, one or more anomalies based on the one or more patterns, generating, by the machine learning model, a recommendation based on the one or more anomalies, and automatically notifying one or more users of the one or more anomalies and the recommendation.

### TECHNICAL FIELD

The present disclosure relates generally to improving data engineering efficiency and, more particularly, to systems and methods for automating and reporting anomaly detection.

### BACKGROUND

When developing software, improvements in efficiency can be beneficial for software companies. While leveraging data tools may be intended to increase efficiency, it may be difficult to manually extract meaningful insights across multiple data tools and programs, or compile insights from multiple, fragmented widgets. As a result, software engineering teams may spend considerable time manually identifying anomalies and interpreting data. In addition, providing real-time notifications of issues or insights may present further delays in software engineering. Even when issues are determined, inefficiencies may be magnified as it may be difficult for developers to collaborate to determine a clear, consistent recommendation for next steps.

There exists a need for an artificial intelligence (AI) driven framework that automates anomaly detection and reporting. In addition, software engineering teams may benefit from a system that provides both dashboard and notification-based insights for faster action response times. Receiving proactive notifications, or being able to refer to an intuitive dashboard offering detailed insights and dynamic reports would enhance team efficiency by providing real-time issue resolution and actionable insights for continuous improvement.

The present disclosure is directed to overcoming one or more of these above-referenced challenges.

### SUMMARY OF THE DISCLOSURE

In some aspects, the techniques described herein relate to a computer-implemented method for automating anomaly detection, the method including: retrieving one or more data metrics from a data server; mapping, by a machine learning model, the one or more data metrics using one or more logic rules; determining, by the machine learning model, one or more patterns based on the mapping; determining, by the machine learning model, one or more anomalies based on the one or more patterns; generating, by the machine learning model, a recommendation based on the one or more anomalies; and automatically notifying one or more users of the one or more anomalies and the recommendation.

In some aspects, the techniques described herein relate to a system for automating anomaly detection, the system including: a data storage device storing instructions for automating anomaly detection in an electronic storage medium; and a processor configured to execute the instructions to perform a method including: retrieving one or more data metrics from a data server; mapping, by a machine learning model, the one or more data metrics using one or more logic rules; determining, by the machine learning model, one or more patterns based on the mapping; determining, by the machine learning model, one or more anomalies based on the one or more patterns; and generating, by the machine learning model, a recommendation based on the one or more anomalies.

In some aspects, the techniques described herein relate to a non-transitory machine-readable medium storing instructions that, when executed by a computing system, cause the computing system to perform a method for automating anomaly detection, the method including: retrieving one or more data metrics from a data server; mapping, by a machine learning model, the one or more data metrics using one or more logic rules; determining, by the machine learning model, one or more patterns based on the mapping; determining, by the machine learning model, one or more anomalies based on the one or more patterns; and generating, by the machine learning model, a recommendation based on the one or more anomalies.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims. As will be apparent from the embodiments below, an advantage to the disclosed systems and methods is that multiple parties may fully utilize their data without allowing others to have direct access to raw data. The disclosed systems and methods discussed below may allow advertisers to understand users' online behaviors through the indirect use of raw data and may maintain privacy of the users and the data.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 illustrates a schematic for automating and reporting anomaly detection according to an example of the present disclosure.

FIG. 2 illustrates a flow diagram for automating and reporting anomaly detection according to an example of the present disclosure.

FIG. 3 illustrates a flow diagram of an exemplary embodiment for automating and reporting anomaly detection according to one or more embodiments.

FIG. 4 illustrates an implementation of a computer system that executes techniques presented herein according to an example of the present disclosure.

### DETAILED DESCRIPTION OF EMBODIMENTS

According to certain aspects of the disclosure, methods and systems are disclosed for automating and reporting anomaly detection.Conventional techniques may not be suitable because conventional techniques, among other things, are unable to provide an automated anomaly detection and reporting method. Accordingly, improvements in software engineering, such as automatically detecting and reporting anomalies, are needed.

When developing software and engineering data, inefficiencies and errors usually affect a company’s bottom line. One way a software company may increase efficiency is by automating certain processes as manual efforts by engineers and developers usually increase opportunities for error. Other inefficiencies may also occur after an error is discovered as engineering or development teams may encounter set-backs when collaborating or taking the time necessary to strategize ways to resolve an issue.

Conventional methods for discovering and resolving errors or anomalies in data do not include a way to automate this process. Instead, conventional systems for addressing errors and anomalies are most often reactionary. For example, a problem arises and then troubleshooting begins. Developers or software engineers must then manually determine the problem, the associated data, and a solution.

This disclosure provides systems and methods for automating anomaly detection. The systems and methods may include retrieving one or more data metrics from a data server. The systems and methods may include mapping, by a machine learning model, the one or more data metrics using one or more logic rules. The systems and methods may include determining, by the machine learning model, one or more patterns based on the mapping. The systems and methods may include determining, by the machine learning model, one or more anomalies based on the one or more patterns. The systems and methods may include generating, by the machine learning model, a recommendation based on the one or more anomalies.

Advantages of such systems and method may include increasing deployment frequency due to real-time notifications providing for faster issue resolution. Advantages may also include decreasing failure rates as responding to anomalies may occur promptly. Another advantage may include decreasing the time to production as continuous and automatic anomaly detection and dynamic reporting may reduce overall lead times. In addition, another advantage may include decreasing troubleshooting response times as development and engineering teams may more quickly adopt solutions via dynamic reports and real-time notifications. Overall, these advantages may provide for a more efficient and improved method of software engineering, and more specifically, a more efficient process of finding and responding to anomalies.

The terminology used below should be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

As used herein, a “machine learning model” generally encompasses instructions, data, or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, certain embodiments may use a machine learning model to process data related to a software or data project to identify anomalies and determine recommendations for addressing the anomalies. Certain embodiments may then report the recommendations and corresponding data anomalies, such as via notifications, a dashboard, or a chat-bot, or any combination thereof.

While several of the examples herein involve data metrics, it should be understood that techniques according to this disclosure may be adapted to any suitable type of data or software engineering project, such as data warehousing, data lakes, data pipelines, and data integration projects, or any other project aimed at making data accessible for analysis and decision-making. It should also be understood that the examples herein are illustrative only. The techniques and technologies of this disclosure may be adapted to any suitable activity.

Presented below are various aspects of machine learning techniques that may be adapted to use data metrics for determining anomalies and generating recommendations. As will be discussed in more detail below, machine learning techniques adapted for determining anomalies and generating recommendations may include one or more aspects according to this disclosure, e.g., a particular selection of training data, a particular training process for the machine learning model, operation of a particular device suitable for use with the trained machine learning model, operation of the machine learning model in conjunction with particular data, modification of such particular data by the machine learning model, etc., and/or other aspects that may be apparent to one of ordinary skill in the art based on this disclosure.

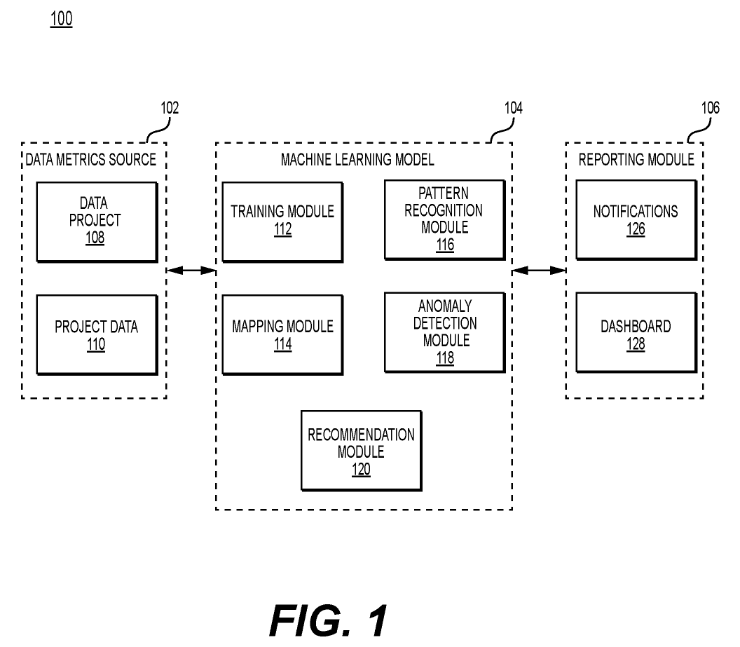

FIG. 1 illustrates a schematic for automating and reporting anomaly detection according to an example of the present disclosure. FIG. 1 depicts an exemplary environment 100 that may be utilized with the techniques, including the systems and method presented herein. As displayed in FIG. 1, data metrics source 102, machine learning model 104, and reporting module 106, may communicate with each other, such as across a network. Data metrics source 102, machine learning model 104, and reporting module 106 may be included in a data storage device storing instructions for automating anomaly detection in an electronic storage medium and a processor configured to execute the instructions to perform one or more methods for automating anomaly detection. As discussed in further detail below, one or more server systems may communicate with one or more of the other components of the environment across a network. While data metrics source 102, machine learning model 104, and reporting module 106 may be included in a single web server, client server, pre-bid server, and third-party server, each web server, client server, pre-bid server, and third-party server may also consist of one or more servers connected over a network. The systems and devices of exemplary environment 100 may communicate in any arrangement, including an arrangement other than what FIG. 1 illustrates.

Data metrics source 102 may include data project 108 and project data 110. Data project 108 may include a project related to aspects of software development or data management. For example, data project 108 may include designing, developing, testing, and maintaining software applications and systems. Data project 108 may include writing code, debugging, collaborating with teams, and understanding the needs of users and stakeholders. In addition, data project 108 may also include data processing and analysis, collecting, preparing, and storing data and may involve creating reports and building machine learning models. Data project 108 may also include applications, plug-ins, and widgets for both web and mobile use.

Project data 110 may include key performance indicators when measuring completion and efficiency of data project 108. For example, project data 110 may include deployment frequency or how often code is deployed to production. Other metrics may reflect the speed and frequency of releases. Project data 110 may also include lead time changes or other metrics related to the time it takes a code commit to reach production. Other related metrics may include how long it takes to deliver changes. Project data 110 may also comprise a mean time to recover, which may include data related to the average time it may take to restore service after a failure. Other metrics may relate to a team’s ability to recover from incidents. Project data 110 may also include a change failure rate or the percentage of deployments that cause failures in production. Project data 110 may also include other metrics that indicate a reliability of a software delivery pipeline, or efficiency metrics that serve as a driving force for data project 108.

Machine learning model 104 may include training module 112, mapping module 114, pattern recognition module 116, anomaly detection module 118, and recommendation module 120.

Training module 112 may include steps and processes for training machine learning model 104. In an exemplary embodiment, training module 112 may include receiving training data datasets, or training data sets for correlating recommendations with pattern mappings and anomalies. In addition, a validation set may also be created to fine-tune machine learning model 104 during training. Training module 112 may include classification, regression, or clustering steps where training data may be fed into a model and allow the model to learn patterns and relationships within the data. During this process, the model may adjust parameters to minimize a loss function or how far predictions are from the actual results. In one exemplary embodiment, inputs such as project data may be trained using optimization algorithms, such as a stochastic gradient descent, to output recommendations.

Training module 112 may also include evaluating a machine learning model to determine how it performs with unseen data. Test set data may compare predictions against true outcomes. Metrics such as accuracy, precision, recall, or mean squared error may be calculated to further determine any necessary adjustments, such as tuning parameters or hyperparameters. In another exemplary embodiment, training module 112 may include ongoing monitoring to ensure outputs of the machine learning model continue to perform accurately, such as if underlying data patterns change. In another exemplary embodiment, a machine learning model may include periodically retraining with new data to maintain and determine accuracy and reliability. Training module 112 may also include training the machine learning model based on scalability to ensure a system scales with increasing data volume.

Mapping module 114 may include connecting data from a data project to project data. For example, project data 110 may include a key performance indicator (KPI) and the KPI may be based on information related to data project 108. In this example, mapping module 114 may be responsible for connecting the KPI with the corresponding data from the data project.

Pattern recognition module 116 may identify patterns in data. In one exemplary embodiment, data normalization may take place prior to identifying patters in project data. In another embodiment, patterns may be identified without any normalization or standardization techniques. Pattern recognition module 116 may include identifying patterns and may utilize thresholds to determine rule-based patterns in data.

Anomaly detection module 118 may include reviewing patterns determined from pattern recognition module 116 to determine anomalies. The anomalies may include a disruption in a pattern of project data 110, or may relate to an anomaly with raw data from data project 108. Anomaly detection module 118 may also continuously monitor data accuracy and validation to ensure correct insights are determined.

Recommendation module 120 may include determining a recommendation based on any combination of patterns, mappings, or anomalies. Recommendations may include suggestions on how an engineering team may address anomalies or breaks in efficiency. Recommendation module 120 may also include identifying specific recommendations to remove data project bottlenecks to improve the overall efficiency of the data project 108. In another exemplary embodiment, recommendation module 120 may determine proactive improvements, such as by utilizing generative AI to identify challenges and to determine and provide specific recommendations for improvement.

Reporting module 106 may include ways to inform and present information determined by recommendation module 120. Reporting module 106 may include providing notifications 126 or by transmitting information and recommendations to a dashboard 128. Notifications 126 may be provided via text, email, slack groups, chat, messaging, video messaging, or any other means of communications to team members or organization members. Notifications 126 may also be integrated with various delivery channels of other communication platforms. In addition, notifications 126 may include real-time alerts to provide immediate notification of anomalies to team members to enable fast response times and corrections. In another exemplary embodiment, notifications 126 may automatically notify one or more users via a custom alert by configuring notifications to custom recipients based on predetermined thresholds or preferences (e.g., deployment failures, low maturity levels, etc.) and determining which users, team members, or developers should receive the custom alert based on the thresholds and preferences. For example, a custom alert may be configured to alert all project managers in the event that a deployment failure rate exceeds a predetermined threshold of one per day. With this exemplary custom configuration, all project managers may be automatically notified without any additional user intervention when a deployment failure rate exceeds one per day.

Notifications 126 may also include immediate response notifications which may allow teams to act on issues without waiting for manual checks. In general, notifications 126 may provide for improved efficiency by facilitating faster response times and overall downtime reductions and deployment delays.

Dashboard 128 may include a user interface that allows users to visualize information, track and benchmark key metrics, and share insights with appropriate team members. Dashboard 128 may also utilize dynamic reporting automations that provide actionable insights tailored to user queries. In another exemplary embodiment, reporting module 106 may track top queries to align improvement strategies across a team or organization. Team members may also be able to view how a team is performing, benchmark metrics across teams and the industry, and determine outcomes based on presented scalability information. Dashboard 128 may also provide a self-service dashboard that tracks software delivery velocity and performance, builds and deployments, and may provide an analyzed cost in real-time.

In one exemplary embodiment, dashboard 128 may provide the ability for users to create and edit dashboards, such as by customizing key metrics that are displayed. Other customizations may include exporting specific data, creating scheduled reports, and setting alerts. In another exemplary embodiment, dashboard 128 may provide dynamic reporting and a way to allow users to query and view important insights. In another embodiment, dashboard 128 may be integrated with a GPT-based recommendations system.

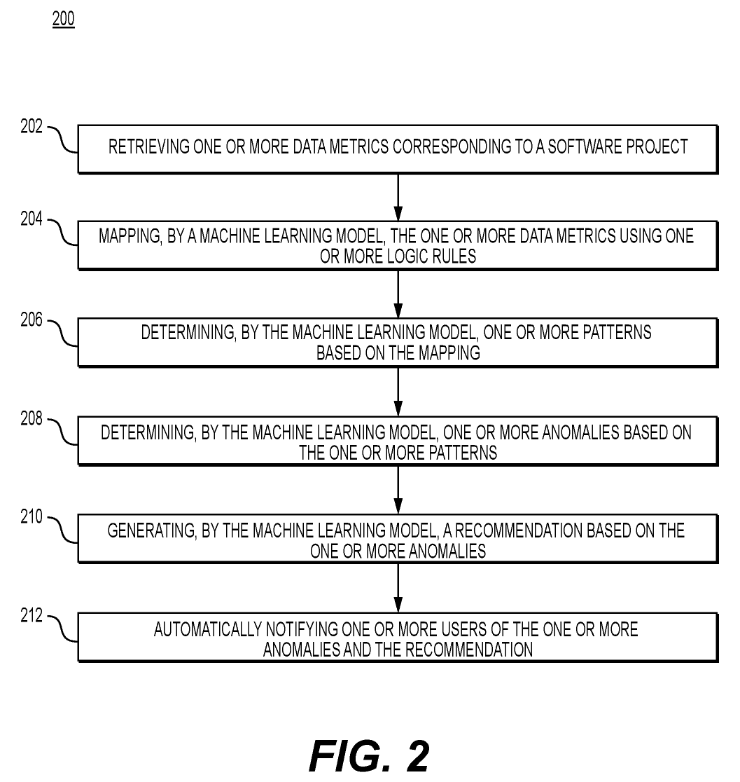

FIG. 2 illustrates a flow diagram for automating and reporting anomaly detection according to an example of the present disclosure. In some embodiments, method 200 may include a step 202, retrieving one or more data metrics from a data server. The one or more data metrics may be transferred between servers, over a network, or from data storage devices, such as databases. In one exemplary embodiment, data metrics may comprise key performance indicators. Other data metrics that are known in the art may also be considered.

In some embodiments, method 200 may include a step 204, mapping, by a machine learning model, the one or more data metrics using one or more logic rules. Mapping may include correlating data metrics to raw data of a data project. In another example embodiment, mapping may include determining rules and associations between the mapped data. In another exemplary embodiment, mapping the data metrics may include using fuzzy logic.

In some embodiments, method 200 may include a step 206 determining, by the machine learning model, one or more patterns based on the mapping. According to another exemplary embodiment, the machine learning model may be trained by receiving, as training data, a plurality of data metric sets and a plurality of patterns and corresponding anomalies, and using the training data to correlate anomalies with patterns of the plurality of data metrics.

In some embodiments, method 200 may include a step 208, determining, by the machine learning model, one or more anomalies based on the one or more patterns. As discussed above, the machine learning model may be trained to determine anomalies based on patterns. A machine learning model may also be trained to detect false positive results, and may be fine-tuned by continuously, or iteratively, modifying thresholds and anomaly detection logic.

In some embodiments, method 200 may include a step 210, generating, by the machine learning model, a recommendation based on the one or more anomalies. In another exemplary embodiment, generating a recommendation may include identifying one or more root causes for the one or more anomalies, identifying a reason for a variance in the one or more patterns, or linking the one or more anomalies to input data.

In some embodiments, method 200 may include a step 212, automatically notifying one or more users of the one or more anomalies and the recommendation. Notifying the one or more users may include transmitting a notification to the one or more users. The notification may include the one or more anomalies and the recommendation. In another exemplary embodiment, step 212 may include determining, based on the one or more anomalies and a predetermined threshold, custom recipients of a custom notification and automatically notifying the custom recipients based on the custom notification.

In another exemplary embodiment, step 212 may include displaying, on a dashboard, one or more anomalies and the recommendation.In addition, step 212 may also include both transmitting a notification and displaying a recommendation via a dashboard.

It is to be understood that method 200 need not necessarily be performed in the exact order described herein and the steps described herein may be rearranged in some embodiments. Further, in some embodiments fewer than all steps of process 300 may be performed and in some embodiments additional steps may be performed.

Overall, this flowchart represents a faster time-to-action method where real-time notifications may lead to quicker response times for data engineering issues and improving overall delivery efficiency. This approach may reduce the need for manual analysis and save valuable time and resources. Overall, the method may improve delivery performance by reducing bottlenecks and delays. The method may also increase efficiency by reducing failure rates and increasing team collaboration.

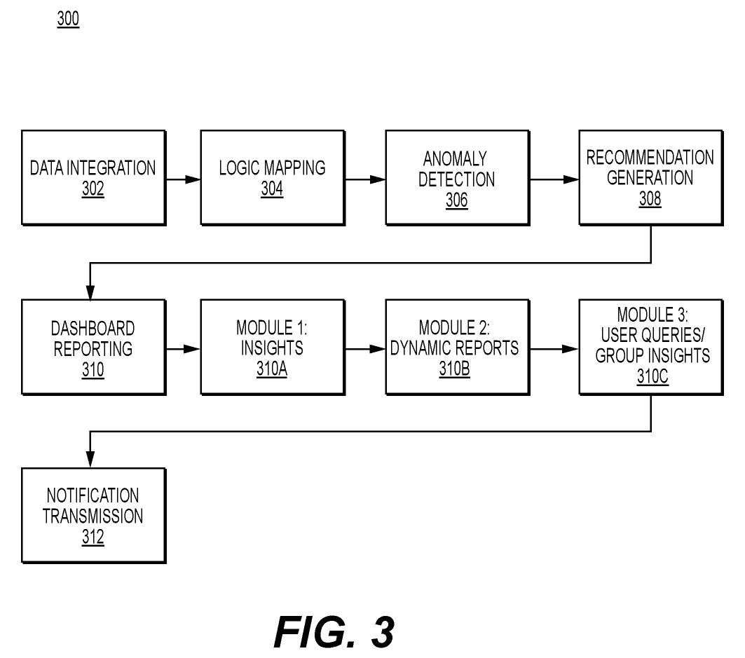

FIG. 3 illustrates a flow diagram of an exemplary embodiment for automating and reporting anomaly detection according to one or more embodiments. FIG. 3 depicts an exemplary flowchart of process 300 that may be utilized with the techniques and methods presented herein, such as in FIG. 2.

In an exemplary embodiment, when a data engineering or software project is underway, process 300 may include data integration 302. In this exemplary embodiment, third party software may provide data or metrics, such as KPIs. For example, data integration 302 may pull real-time data from Harness Insight. While Harness Insight is used for exemplary purposes, other third party software may also be considered.

Logic mapping 304 may include mapping KPIs to raw data. In this exemplary embodiment, fuzzy logic mapping may be used to map the KPIs to raw data from a data project. In another embodiment, fuzzy logic mapping may also be used to assess maturity levels of the data project data by using fuzzy logic rules based on the raw data metrics. As an example, maturity levels may be assessed by mapping raw and often imprecise data (like scores, percentages, or sensor values) into qualitative assessments (e.g., "Low", "Medium", "High" maturity) using fuzzy logic rules instead of thresholds. In this example, maturity may be determined by using fuzzy logic to allow for degrees of truth to determine "Low", "Medium", "High" maturity, rather than binary data (e.g., true/false, or “0” and “1”).

Anomaly detection 306 may include determining one or more anomalies in relation to the KPIs and may further include determining the data from which an anomaly KPI corresponds. For example, anomaly detection 306 may include detecting key issues using fuzzy rules and thresholds. If an anomaly is detected, anomaly detection 306 may identify the data causing the anomaly KPI and trigger notifications.

Recommendation generation 308 may include generating a tailored improvement strategy based on the detected anomaly. In this exemplary embodiment, recommendation generation 308 may also include the data metrics that are involved and how to fix or address those data metrics.

Dashboard reporting 310 may include different modules, such as Module 1: insights 310A, Module 2: dynamic reports 310B, and Module 3: user queries/group insights 310C. Insights 310A may include providing information learned from the detected anomalies. Insights 310A may be a report, email, or any other one-way form of communication. Dynamic reports 310B may be a two-way form of communication. For example, dynamic reports 310B may include generating dynamic reports from user queries by using natural language processing. In this example, dynamic reports 310B may be similar to a chat bot where team members may ask questions, and using natural language processing, a dynamic reporting is provided. Group insights 310C may include utilizing a dashboard to provide and display top user queries or group insights.

Notification transmission 312 may include transmitting the information prepared in dashboard reporting 310 to team members and users. Notification transmission 312 may occur quickly or in real-time based on the determination of an anomaly.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

In general, any process or operation discussed in this disclosure that is understood to be computer-implementable, such as the systems or devices in the exemplary environment 100 of FIG. 1, or any of the processes illustrated in FIGS. 2-3, may be performed by one or more processors of a computer system as described herein. A process or a process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices in FIGS. 1 and 3. One or more processors of a computer system may be included in a single computing device or distributed among a multitude of computing devices. A memory of the computer system may include the respective memory of each computing device of the plurality of computing devices.

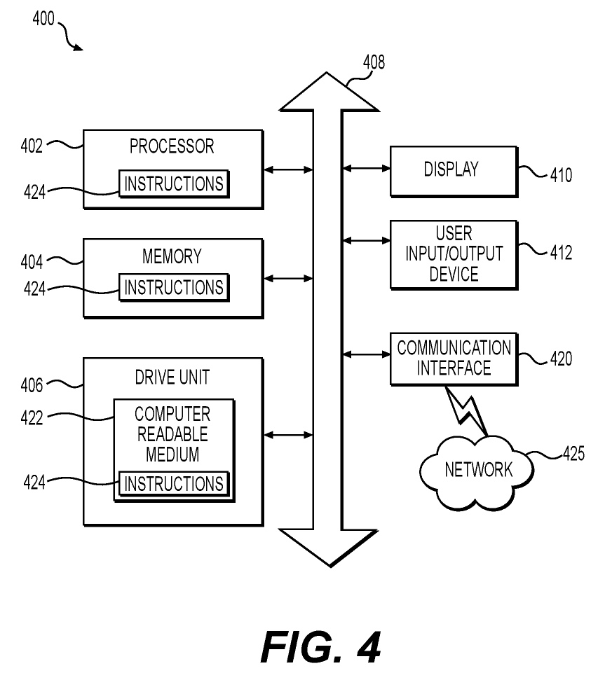

FIG. 4 illustrates an implementation of a computer system that executes techniques presented herein according to an example of the present disclosure. FIG. 4 is a simplified functional block diagram of a computer system 400 that may be configured as a device for executing the method of FIG. 2 and the exemplary flow chart of FIG. 3, according to exemplary embodiments of the present disclosure. For example, FIG. 4 illustrates an implementation of a computer system that may execute techniques presented herein. The computer system 400 can include a set of instructions that can be executed to cause the computer system 400 to perform any one or more of the methods or computer-based functions disclosed herein. The computer system 400 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action or processes of a computer or computing system, or similar electronic computing device, that manipulate or transform data represented as physical, such as electronic, quantities into other data similarly represented as physical quantities.

In a similar manner, the term “processor” may refer to any device or portion of a device that processes electronic data, e.g., from registers or memory to transform that electronic data into other electronic data that, e.g., may be stored in registers or memory. A “computer,” a “computing machine,” a “computing platform,” a “computing device,” or a “server” may include one or more processors.

In a networked deployment, the computer system 400 may operate in the capacity of a server or as a client user computer in a server-client user network environment, or as a peer computer system in a peer-to-peer (or distributed) network environment. The computer system 400 can also be implemented as or incorporated into various devices, such as a personal computer (PC), a tablet PC, a personal digital assistant (PDA), a mobile device, a palmtop computer, a laptop computer, a desktop computer, a web appliance, or any other machine capable of executing a set of instructions (sequential or otherwise) that specify actions to be taken by that machine. In a particular implementation, the computer system 400 may be implemented using electronic devices that provide voice, video, or data communication. Further, while the computer system 400 is illustrated as a single system, the term “system” shall also be taken to include any collection of systems or sub-systems that individually or jointly execute a set, or multiple sets, of instructions to perform one or more computer functions.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 may include a cache or random-access memory for the processor 402. In alternative implementations, the memory 404 is separate from the processor 402, such as a cache memory of a processor, the system memory, or other memory.

The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the processor 402 executing the instructions stored in the memory 404. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 400 may further include a display 410, such as a liquid crystal display (LCD), an organic light emitting diode (OLED), a flat panel display, a solid-state display, a cathode ray tube (CRT), a projector, a printer or other now known or later developed display device for outputting determined information. The display 410 may act as an interface for the user to see the functioning of the processor 402, or specifically as an interface with the software stored in the memory 404 or in the drive unit 406.

Additionally or alternatively, the computer system 400 may include an input/output device 412 configured to allow a user to interact with any of the components of the computer system 400. The input/output device 412 may be a number pad, a keyboard, or a cursor control device, such as a mouse, or a joystick, touch screen display, remote control, or any other device operative to interact with the computer system 400.

The computer system 400 may also or alternatively include drive unit 406, implemented as a disk or optical drive. The drive unit 406 may include a computer-readable medium 422 in which one or more sets of instructions 424, e.g., software, can be embedded. Further, instructions 424 may embody one or more of the methods or logic as described herein. The instructions 424 may reside completely or partially within the memory 404 or within the processor 402 during execution by the computer system 400. The memory 404 and the processor 402 also may include computer-readable media as discussed above.

In some systems, computer-readable medium 422 includes instructions 424 or receives and executes instructions 424 responsive to a propagated signal so that a device connected to network 425 can communicate voice, video, audio, images, or any other data over the network 425. Further, instructions 424 may be transmitted or received over the network 425 via communication port or interface 420, or using bus 408. The communication port or interface 420 may be a part of the processor 402 or may be a separate component. The communication port or interface 420 may be created in software or may be a physical connection in hardware.

The communication port or interface 420 may be configured to connect with a network 425, external media, the display 410, or any other components in computer system 400, or combinations thereof. The connection with the network 425 may be a physical connection, such as a wired Ethernet connection or may be established wirelessly as discussed below. Likewise, the additional connections with other components of the computer system 400 may be physical connections or may be established wirelessly. The network 425 may alternatively be directly connected to the bus 408.

While the computer-readable medium 422 is shown to be a single medium, the term “computer-readable medium” may include a single medium or multiple media, such as a centralized or distributed database, or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 422 may be non-transitory, and may be tangible.

The computer-readable medium 422 can include a solid-state memory such as a memory card or other package that houses one or more non-volatile read-only memories. The computer-readable medium 422 can be a random-access memory or other volatile re-writable memory. Additionally or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 400 may be connected to network 425. The network 425 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 425 may include wide area networks (WAN), such as the Internet, local area networks (LAN), campus area networks, metropolitan area networks, a direct connection such as through a Universal Serial Bus (USB) port, or any other networks that may allow for data communication.

The network 425 may be configured to couple one computing device to another computing device to enable communication of data between the devices. The network 425 may generally be enabled to employ any form of machine-readable media for communicating information from one device to another. The network 425 may include communication methods by which information may travel between computing devices.

The network 425 may be divided into sub-networks. The sub-networks may allow access to other components connected thereto or the sub-networks may restrict access between the components. The network 425 may be regarded as a public or private network connection and may include, for example, a virtual private network or an encryption or other security mechanism employed over the public Internet, or the like.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, or functionality of computer-implemented methods discussed are performed in one embodiment by an appropriate processor (or processors) of a processing (i.e., computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims. To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in a temporary configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules in different instances. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

In this disclosure, the term “based on” means “based at least in part on.” The term “exemplary” is used in the sense of “example” rather than “ideal.” The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). Relative terms, such as, “substantially,” “generally,” and “approximately” are used to indicate a possible variation of ±10% in a stated value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for automating anomaly detection, the method comprising:
retrieving one or more data metrics from a data server;
mapping, by a machine learning model, the one or more data metrics using one or more logic rules;
determining, by the machine learning model, one or more patterns based on the mapping;
determining, by the machine learning model, one or more anomalies based on the one or more patterns;
generating, by the machine learning model, a recommendation based on the one or more anomalies; and
automatically notifying one or more users of the one or more anomalies and the recommendation.

2. The computer-implemented method of claim 1, further comprising:
determining, based on the one or more anomalies and a predetermined threshold, custom recipients of a custom notification; and
automatically notifying the custom recipients based on the custom notification.

3. The computer-implemented method of claim 1, further comprising:
displaying on a dashboard the one or more anomalies and the recommendation.

4. The computer-implemented method of claim 1, wherein the one or more data metrics comprise key performance indicators.

5. The computer-implemented method of claim 1, wherein mapping the one or more data metrics includes using fuzzy logic.

6. The computer-implemented method of claim 1, wherein the recommendation includes one or more of identifying root causes for the one or more anomalies, identifying a reason for a variance in the one or more patterns, and linking the one or more anomalies to input data; and
wherein the recommendation is automatically displayed via a dashboard of a graphical user interface.

7. The computer-implemented method of claim 1, wherein the machine learning model has been trained by receiving, as training data, a plurality of data metric sets and a plurality of patterns and corresponding anomalies, and
using the training data to correlate anomalies with patterns of the plurality of data metrics.

8. A system for automating anomaly detection, the system comprising:
a data storage device storing instructions for automating anomaly detection in an electronic storage medium; and
a processor configured to execute the instructions to perform a method including:
retrieving one or more data metrics from a data server;
mapping, by a machine learning model, the one or more data metrics using one or more logic rules;
determining, by the machine learning model, one or more patterns based on the mapping;
determining, by the machine learning model, one or more anomalies based on the one or more patterns;
generating, by the machine learning model, a recommendation based on the one or more anomalies; and
automatically notifying one or more users of the one or more anomalies and the recommendation.

9. The system of claim 8, further comprising:
determining, based on the one or more anomalies and a predetermined threshold, custom recipients of a custom notification; and
automatically notifying the custom recipients based on the custom notification.

10. The system of claim 8, further comprising:
displaying on a dashboard the one or more anomalies and the recommendation.

11. The system of claim 8, further comprising:
wherein the one or more data metrics comprise key performance indicators.

12. The system of claim 8, wherein mapping the one or more data metrics includes using fuzzy logic.

13. The system of claim 8, wherein the recommendation includes one or more of identifying root causes for the one or more anomalies, identifying a reason for a variance in the one or more patterns, and linking the one or more anomalies to input data; and
wherein the recommendation is automatically displayed via a dashboard of a graphical user interface.

14. The system of claim 8, wherein the machine learning model has been trained by receiving, as training data, a plurality of data metric sets and a plurality of patterns and corresponding anomalies, and
using the training data to correlate anomalies with patterns of the plurality of data metrics.

15. A non-transitory machine-readable medium storing instructions that, when executed by a computing system, cause the computing system to perform a method for automating anomaly detection, the method including:
retrieving one or more data metrics from a data server;
mapping, by a machine learning model, the one or more data metrics using one or more logic rules;
determining, by the machine learning model, one or more patterns based on the mapping;
determining, by the machine learning model, one or more anomalies based on the one or more patterns;
generating, by the machine learning model, a recommendation based on the one or more anomalies; and
automatically notifying one or more users of the one or more anomalies and the recommendation.

16. The non-transitory machine-readable medium of claim 15, further comprising:
determining, based on the one or more anomalies and a predetermined threshold, custom recipients of a custom notification; and
automatically notifying the custom recipients based on the custom notification.

17. The non-transitory machine-readable medium of claim 15, wherein the one or more data metrics comprise key performance indicators.

18. The non-transitory machine-readable medium of claim 15, wherein mapping the one or more data metrics includes using fuzzy logic.

19. The non-transitory machine-readable medium of claim 15, wherein the recommendation includes one or more of identifying root causes for the one or more anomalies, identifying a reason for a variance in the one or more patterns, and linking the one or more anomalies to input data; and
wherein the recommendation is automatically displayed via a dashboard of a graphical user interface.

20. The non-transitory machine-readable medium of claim 15, wherein the machine learning model has been trained by receiving, as training data, a plurality of data metric sets and a plurality of patterns and corresponding anomalies, and
using the training data to correlate anomalies with patterns of the plurality of data metrics.
